(19) United States
(12) Patent Application Publication
(10) Pub. No.: US 2004/0108077 A1
(43) Pub. Date: Jun. 10, 2004

(54) Apparatus and method for forming polymer crumb

(76) Inventors: Joe Jerry Flores, Sugar Land, TX (US); Rong-Her Jean, Sugar Land, TX (US); Chin-Yan George Ma, Sugar Land, TX (US)

Correspondence Address: MICHAEL MASSE, Kraton Polymers U.S. LLC, 3333 Highway 6 South, Houston, TX, 77082, US

(21) Appl. No.: 10/298,686

(22) Filed: Nov. 18, 2002

(51) Int. Cl. B01D 1/30; C02F 1/06; B01D 1/00

(52) U.S. Cl. 159/2.1; 159/DIG. 10; 528/501

(57) ABSTRACT

The present invention provides a contactor apparatus and method for removing solvent from a polymer cement. The resulting polymer is substantially free of solvent and exhibits improved porosity and more uniform particle size distribution. In one embodiment, a contactor apparatus consists of a cylindrical casing having a high pressure section, a convergence section, a high velocity section, a divergence section, and a discharge section. The polymer cement is introduced into the high pressure section to significantly and unexpectedly improve solvent removal. The convergence and divergence sections preferably have cross-sectional areas that correspond to an effective angle from about 4° to about 65°. The polymer cement is mixed with high pressure steam. After converging, the polymer cement forms more uniform droplets due to high shear of steam. In the divergence and discharge sections, the polymer is substantially devolatized.

### BACKGROUND OF THE INVENTION

1. Field of the Invention

This invention relates to an apparatus and method for removing a solvent from a polymer cement. More particularly, the invention relates to an efficient apparatus and method for devolatilizing polymer cement.

2. Background of the Related Art

After solution polymerization of a monomer, it becomes necessary to isolate the polymer from its solvent. A method of isolation for certain polymers, such as conjugated diene polymers and copolymers, utilizes a high shear mixer whereby the polymer solution or “cement” is combined with high-pressure steam in a mixing zone of a cylindrical tube. The temperature of the steam is above the maximum boiling point of the solvent and below the temperature at which the polymer will show evidence of appreciable decomposition under the conditions of high shear contact. The ratio of steam to solution and the residence time in the mixing zone are sufficient to vaporize at least about 90% of the solvent. The polymer is thereby isolated from the solution, e.g. as a polymer crumb. The sheared mixture is then passed into a cyclone separation zone wherein the polymer is separated from the steam and any vaporized solvent. This process is described in U.S. Pat. No. 3,804,145, issued Apr. 16, 1974, which is incorporated by reference herein.

U.S. Pat. No. 3,804,145 also teaches a high shear contactor having a central zone with an adjustable flow constrictor mounted therein. The cement is fed through an opening into a high shear, annular space formed by the constrictor within the central zone. The cement is contacted with steam in the annular space where the solvent begins to vaporize. The mixture of steam, vaporized solvent, and polymer then exit the open end of the contactor at near sonic speeds.

U.S. Pat. No. 3,202,647 teaches a method using a mixer having a high shear portion. In particular, the reference teaches a process for recovering elastomers from hydrocarbon solutions wherein the steam and polymer cement are mixed together and injected into the bottom of a hot water vessel by a steam jet system. The steam ejector described in the patent is generally in the configuration of a converge-diverge shape such as the construction of a Penberthy steam ejector. The system description taught by U.S. Pat. No. 3,202,647 is incorporated by reference herein.

While the foregoing designs are adequate for separating certain polymer cements from solvent, the designs are less efficient for removal of solvent from some polymers such as high molecular weight block copolymers. For example, when forming crumb of an elastomeric block polymer having a large hydrogenated block of a conjugated diene and two polystyrene end blocks, contactors of the prior art design result in polymer crumb that causes poor particle size distribution and poor porosity. Ideally, the particle size distribution of polymer particles will indicate that most particles fall within a range that facilitates processing, e.g., small amounts of large or small particles. Crumb porosity is important because it determines the speed at which the crumb will absorb a liquid like mineral oil which is often blended with the polymer crumb. Porosity is indirectly related to the bulk density of the crumb under a similar particle size distribution condition whereby a higher bulk density is indicative of a more solid, less porous structure.

In addition to unacceptably high solvent content, the prior art contactors are inefficient in their use of steam. Steam consumption is a major expense in a commercial polymer finishing operation. To achieve sufficient solvent removal in a prior art contactor, a steam to cement weight ratio of about 1.2:1.0 to 1.5:1.0 is required. In other words, for every pound of polymer cement treated in the prior art contactor, 1.2 to 1.5 lbs of high pressure steam is consumed.

Therefore, there is a need for a method and apparatus for separating a polymer from its solvent which results in more efficient solvent removal.

### SUMMARY OF THE INVENTION

The present invention provides an improved method and apparatus for separating polymer from solvent using high pressure steam. In one aspect of the invention, a contactor is comprised of a cylindrical casing having a high pressure section, a convergence section, a high velocity section, a divergence section, and a discharge section. The polymer cement is introduced into the high pressure section where it mixes with the steam and begins to form into droplets. The convergence and divergence sections are preferably tapered to provide a change in cross-sectional area corresponding to an effective angle from about 4° to about 65°. The high velocity section forms a uniform droplet size and prevents the mixture from flashing or devolatizing prematurely. As the mixture passes through the high velocity section, the mixture reaches a supersonic speed creating a near vacuum in the divergence section and causing the polymer cement to devolatilize. As the flashing mixture continues to flow through the divergence section and into the discharge section, the flashing solvent is substantially separated from the polymer.

In another aspect of the invention, a contactor includes a plug having multiple diameters that form various annular regions therein to provide a change in cross-sectional area corresponding to a preferable effective angle from about 4° to about 65°.

In still another aspect of the invention, a method for separating solvent from a polymer cement in a contactor apparatus comprises introducing high pressure steam and the polymer cement into a first section having a substantially constant cross-sectional area; mixing the steam and polymer cement in the first section. The mixture then flows through a second section having a converging cross-sectional area corresponding to a preferable effective angle of convergence from about 4° to about 65°. The mixture then flows through a third section having a substantially constant cross-sectional area followed by a fourth section having a diverging cross-sectional area corresponding to a preferable effective angle of divergence from about 4° to about 65°. The solvent is flashed from the polymer in the fourth section and the mixture flows through a discharge section having a substantially constant cross-sectional area before recovering a polymer substantially free of the solvent.

The invention produces finely divided polymer particles with low residual solvent and water levels enabling down-stream process simplifications. Reduced residual solvent content also reduces the tack or stickiness and tendency for the polymer to agglomerate. The described method and apparatus enables the isolation in powdered form of high molecular weight block copolymers which cannot be easily processed by the prior art.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a contactor apparatus according to the present invention;

FIG. 2 is an alternative embodiment of the contactor apparatus; and

FIG. 3 shows the particle size distributions of polymer formed by the present invention compared to that formed by the prior art.

### DETAILED DESCRIPTION OF THE PREFERRED EMBODIMENT

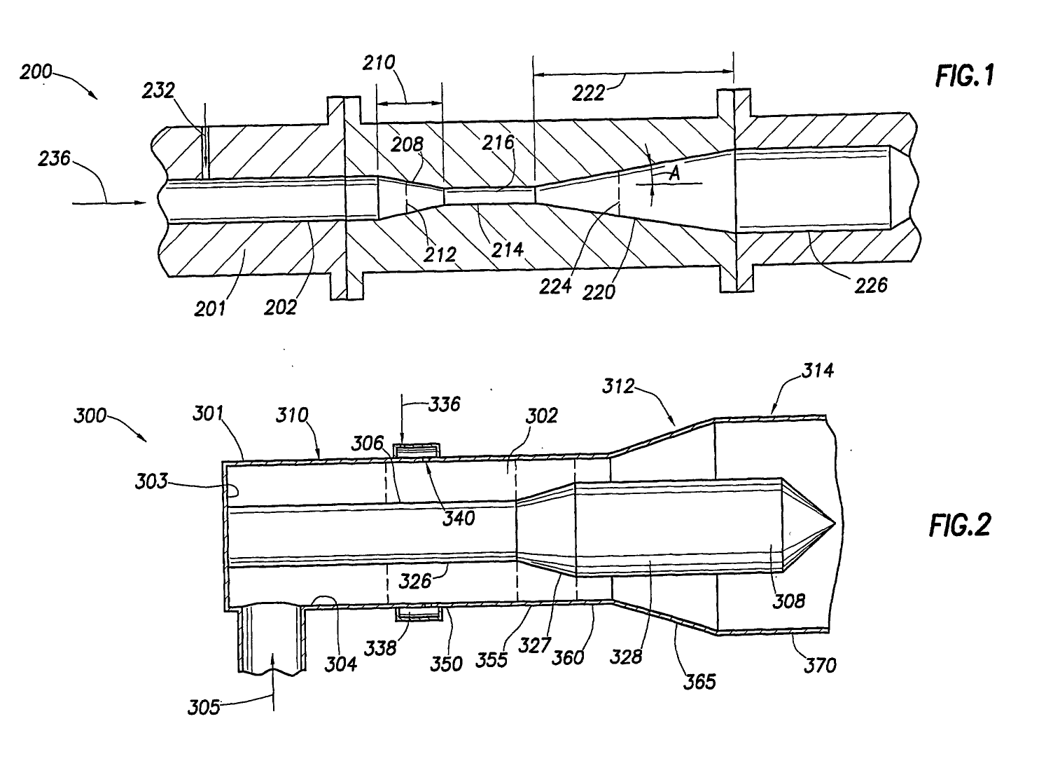

FIG. 1 depicts one embodiment of a contactor apparatus 200 according to the present invention. The contactor 200 includes a cylindrical casing 201 having a high pressure section 202; a convergence section 208; a high velocity section 214; a divergence section 220; and a discharge section 226. The high pressure section 202 includes a cement entry port 232 where the polymer cement is fed into the contactor 200. The cement entry port 232 preferably has a slot design and can be located anywhere along the first section 202. Preferably the cement entry port is located from 4 inches to 7 inches from the start of the convergence section 208. Location of the cement entry port 232 on the high pressure section 202 significantly and unexpectedly improves solvent removal for a wide variety of contactors.

In the embodiment shown in FIG. 1, the high velocity section 214 preferably has a ratio of length to diameter ranging from about 8 to about 12. The high velocity section 214 preferably provides sufficient flow restriction to achieve sonic velocity in the divergence section 220. The ratio of the cross-sectional area of the high pressure section 202 to the cross sectional area of the high velocity section preferably ranges from about 5 to about 7. The cross-sectional area of the discharge section 226 to the cross-sectional area of the high velocity section 214 preferably ranges from about 15 to about 30. The convergence section 208 has a length 210 and a decreasing inner diameter 212 which provides a decreasing cross-sectional area that corresponds to an effective angle of convergence from about 4° to about 65°, preferably from about 4° to about 45°, along the length 210 of the convergence section 208. The divergence section 220 has a length 222 and an inner diameter 224 which provides an increasing cross-sectional area that corresponds to an effective angle of divergence from about 4° to about 65°, preferably from about 4° to about 63°, along the length 222 of the section 220.

Convergence and divergence can be achieved by varying the inner dimension of the contactor as described for FIG. 1, by varying the outer dimension of a plug within the contactor as described below for FIG. 2, or by combinations thereof. Thus, the effective angle of convergence or divergence of the annular processing region accounts for changes in the inner diameter of the casing 201 and any changes in the outer diameter of any plug. The effective angle of convergence or divergence is shown by plotting the effective radius of the cross-sectional area along the length of the contactor assuming a circular cross-section. Thus, a cross-sectional view of a pipe having converging and diverging sections with a plug directly shows the effective angles of convergence and divergence, e.g, angle A in FIG. 1.

In operation, high-pressure steam is introduced at the end 236 of the high pressure section 202. The temperature of the steam at the contactor is between about 335° F. and about 550° F., preferably between about 365° F. and about 550° F. and more preferably between about 400° and 550° F. The pressure of the steam at the contactor is 100 psig to 450 psig, preferably 150 psig to 350 psig. Polymer cement is fed to the contactor 200 through the cement entry port 232. The cement concentration may vary from about 5 percent polymer to about 60 percent polymer by weight. More preferred are cements which vary from about 5 percent polymer to about 25 percent polymer by weight. Particularly preferred are cement concentrations from about 10 percent polymer to about 20 percent polymer by weight. The pressure drop across the cement entry port is preferably designed to be in a range from about 10 psi to about 60 psi to control the initial cement drop size.

Within the high pressure 202 and convergence sections 208, the steam and cement are mixed and intimately contacted. The cement to steam ratio passing through the contactor apparatus determines the size of the polymer particles. The ratio of steam to cement which enters down-stream processing equipment via the high shear mixer may vary from about 0.3:1.0 to about 1.5:1.0. The lower limit is determined by the problem of obtaining discrete particles. The maximum ratio is determined by economics and the ability of the down-stream processing equipment to remove the solvent vapor and steam. At steam to cement ratios substantially lower than 0.3:1.0, the polymer no longer forms discrete particles but forms large agglomerates. The higher the steam to cement ratio in the contactor, the smaller the particle size. This size is somewhat dependent on polymer/solvent type, cement concentration and steam temperature but, by far, the most influential method of varying the polymer size can be achieved by varying the steam to cement ratio. Acceptable particle sizes have been achieved at steam/cement ratios from about 0.3:1.0 to about 1.5:1.0, preferably between about 0.5:1.0 and about 1.5:1.0, and more preferably between about 0.5:1.0 and about 0.8:1.0.

As the cement and steam are mixed, solvent droplets begin to form due to the shearing effect from the high-speed steam. As the mixture flows into the high velocity section 214, the cement droplets are broken up and a relatively uniform distribution of droplets is established. The material accelerates to supersonic speed as it flows through the high velocity section 214 and enters the divergence section 220. Due to the sudden enlargement of volume within the divergence section 220, a near vacuum is created by pressure differential. This sudden pressure drop results in a rapid de-volatilization of the solvent, and a sufficient separation of the flashing solvent from the polymer crumb.

FIG. 2 shows an alternative embodiment of a contactor 300 of the present invention. In this embodiment, the contactor 300 includes a cylindrical casing 301, a plug 308 positioned within the casing 301, and an annulus 302 formed between an inner wall 304 of the casing 301 and an outer wall 306 of the plug 308. The plug 308 can extend through an end wall 303 of the contactor 300 near a solvent inlet 305 as shown, or a plug could be held in place with one or more spacers (not shown).

The cylindrical casing 301 has first, second, and third portions 310, 312, 314. The first portion 310 and third portion 314 have constant inner diameters. The second portion 312 has an increasing inner diameter area. The plug 308 has first, second, and third portions 326, 327, 328. The first and third portions 326, 328 have a constant outer diameter. The second portion 327 has an increasing outer diameter.

The annulus 302 has mixing, convergence, high shear, divergence, and discharge sections 350, 355, 360, 365, 370 with the corresponding portions of the annulus 302 having the preferred ratios of cross-sectional areas as described for FIG. 1. The mixing section 350 comprises the annular space between the constant inner diameter of the first portion 310 of the casing 301 and the constant outer diameter of the first portion 326 of the plug 308, and has a substantially constant cross-sectional area. Substantially constant means that the effective angle of convergence or divergence of the cross-sectional area is from 0° to about 4°. The convergence section 355 comprises the annular space between the constant inner diameter of the first portion 310 of the casing 301 and the increasing outer diameter of the second portion 327 of the plug 308, and has a converging cross-sectional area with an effective angle of convergence from about 4° to about 65°, preferably from about 4° to about 45°. The high shear section 360 comprises the annular space between the constant inner diameter of the first portion 310 of the casing 301 and the constant outer diameter of the third portion 328 of the plug 308, and has a substantially constant cross-sectional area. The divergence section 365 comprises the annular space between the increasing inner diameter of the second portion 312 of the casing 301 and the constant outer diameter of the third portion 328 of the plug 308, and has a diverging cross-sectional area with an effective angle of divergence from about 4° to about 65°, preferably from about 4° to about 63°. The discharge section 370 comprises the annular space between the constant inner diameter of the third portion 314 of the casing 301 and the constant outer diameter third portion 328 of the plug 308, and has a substantially constant cross sectional area.

The polymer cement is introduced through an inlet port 336 into the first portion 301 of the casing 301. The inlet port 336 preferably introduces the polymer cement into an annular space 338 that directs the polymer cement through a slot 340 around the casing 301. The width of the slot 340 can be adjusted to provide the desired pressure drop of from about 10 psi to about 60 psi.

In operation of this alternative embodiment, high-pressure steam flows through the first portion 310 of the casing 301 while a polymer cement material is fed through the inlet port 336 in communication with the slot 340 in the casing 301. The steam and polymer cement are mixed together in the mixing section 350 where solvent droplets begin to form due to the shearing effect from the steam. The droplets further form and breakup within the convergence section 355. The mixture accelerates to sonic speed as it flows through the high shear section 360. The high velocity shears or separates the droplets into tiny particles forming a relatively uniform distribution. The sudden enlargement of volume within the divergence section 365 rapidly flashes the solvent thereby separating the cement.

The present invention is based upon the finding that the contactor geometry allows a certain residence time at a high shear rate to produce a polymer product of lowest residual solvent. The high shear annular space in the high velocity sections as well as the length of the diverging sections determine the shear rate and the residence time thereby reducing residual solvent in the polymer product. As the length of the diverging sections is increased, the residence time under shearing conditions is also increased thus allowing more time for the cement de-volatization.

One of the most beneficial characteristics of the above described high shear contactor lies in the low residual solvent and water contents, minimization of steam consumption, as well as the fine particle size of the polymer. The lower the water level, the more easily the polymer is dried. Water is produced by the condensation of steam necessary to flash the solvent from the cement. The low residual solvent means that the polymer is less sticky, thus enabling a dry handling method.

Steam represents a large expense in any de-volatilization process. In prior art contactors, the relation of steam to cement has been about 1.2 to 1.5 pounds of steam for every pound of cement. The apparatus of the present invention de-volatizes polymer cement in a near vacuum therefore consuming considerably less steam. For example, steam usage within the contactor of the present invention is on the order of 0.6 pounds of steam for every pound of cement, a savings of 50 to 60% compared to the prior art.

FIG. 3 shows the comparative particle size distributions of a polymer crumb formed by the prior art, wherein cement is injected in the high shear section, and the present invention wherein cement is injected prior to a convergence section having an effective angle of convergence of 6°. An ideal distribution of particle size has the largest percentage of particles falling within a desired range to reduce dust or large particles that are more difficult to blend. As shown in FIG. 3, a sample of polymer crumb made with a prior art contactor included about 29% by weight of very small particles with diameters less than 0.425 mm, and about 24% by weight of very large particles having a diameter of about 2.36 mm, in comparison to about 11% by weight and about 8% by weight for the present invention, respectively. The samples of the present invention resulted in about 52% by weight of particle sizes falling within the mid range of 0.6 mm to 1.18 mm in comparison to about 26% by weight for the prior art contactor. The test samples illustrated in FIG. 3 also demonstrate the efficient use of steam by the contactors of the present invention. Compared to the prior art contactor which used a steam to cement ratio of 1.2:1 or 1.2 lbs. of steam for every pound of cement, the contactors of the present invention used 0.61 lbs. of steam for every pound of cement, a steam savings of about 50%.

Bulk density is dependent on particle size and porosity. Bulk density can be measured by taking a known weight of sample polymer and measuring its volume. The smaller the bulk density is, the more porous the polymer is if the particle size distribution is similar. Indeed, bulk density tests performed upon the various samples show that the polymer crumb produced by the contactors of the present invention has a much lower bulk density. The samples of crumb made with the contactors of the present invention had a bulk density of 13.2 lbs/ft³. The samples made with the prior art contactor resulted in a crumb bulk density of 18 lbs/ft³. Thus, the contactors of the current invention, shown in FIGS. 1 and 2, have consistently produced polymer crumb having better porosity and uniform distribution of size than the prior art. FIG. 3 demonstrates those results.

This polymer recovery method together with the method for controlling particle size is useable with any polymer/solvent cement system that can withstand the high temperature steam without decomposing or cross-linking. It is especially good with polyolefin/hydrocarbon cements, polyalkenyl aromatic polymers/inert solvent cements, polyconjugated diene polymer/hydrocarbon cements, copolymers and block-polymers of conjugated diene and alkenyl aromatic hydrocarbons in inert solvents and the hydrogenated and partially hydrogentated derivatives of the above co-polymers and block polymers in inert solvents. The preferred cements are the two and multiblock alpha alkenyl aromatic hydrocarbon/conjugated diene polymers and selectively or totally hydrogenated derivatives of said block polymers preferably dissolved in hydrocarbon solvents having relatively low boiling points such as alkenes, alkanes, arenes, cycloalkenes, or cycloalkanes. These include for example, mixed pentenes, mixed pentanes, cyclohexane, toluene, and mixtures thereof, the only criterion being that the solvent employed in the apparatus and process of the invention have a maximum boiling point such that it is readily vaporized upon contact with steam of a given temperature. The particularly preferred cements are the polystyrene/polybutadiene, polystyrene/polyisoprene, polystyrene/polybutadiene/polystyrene, polystyrene/polyisoprene/polystyrene block copolymers, or their hydrogenated or partially hydrogenated derivatives.

While foregoing is directed to the preferred embodiment of the present invention, other and further embodiments of the invention may be devised without departing from the basic scope thereof, and the scope thereof is determined by the claims that follow.

What is claimed is:

1. A contactor apparatus for separating solvent from a polymer cement comprising:
a first section having an inlet for the polymer cement;
a second section having a converging cross-sectional area;
a third section having a smaller cross-sectional area in comparison to the first section;
a fourth section having a diverging cross-sectional area; and
a discharge section having a larger cross-sectional area in comparison to the third section.

2. The apparatus of claim 1, wherein the second section has an effective angle of convergence from about 4° to about 65°, and the fourth section has an effective angle of divergence from about 4° to about 65°.

3. The apparatus of claim 2, wherein the second section has an effective angle of convergence between about 4° and about 45°, and the fourth section has an effective angle of divergence between about 4° and about 63°.

4. The apparatus of claim 1, wherein the ratio of cross-sectional areas of the first section to the third section ranges from about 5 to about 7, and the ratio of cross-sectional areas of the discharge section to the third section ranges from about 15 to about 30.

5. The apparatus of claim 4, wherein the third section has a ratio of length to diameter from about 8 to about 12.

6. The apparatus of claim 1, wherein the second section has a decreasing inner diameter and the fourth section has an increasing inner diameter.

7. The apparatus of claim 1, wherein the second section contains a plug having an increasing outer diameter and the fourth section has an increasing inner diameter.

8. The apparatus of claim 1, wherein the inlet for the polymer cement is a slot.

9. A method for separating solvent from a polymer cement in a contactor apparatus comprising:
introducing high pressure steam and the polymer cement into a first section;
mixing the steam and polymer cement in the first section;
flowing the mixture through a second section having a converging cross-sectional area;
forming droplets comprised of the solvent;
flowing the mixture through a third section having a ratio of length to diameter ranging from about 8 to about 12;
flowing the mixture through a fourth section having a diverging cross-sectional area;
flashing the solvent from the polymer;
flowing the polymer and the solvent through a discharge section; and
separating polymer particles having improved particle size distribution and porosity from the solvent.

10. The method of claim 9, wherein the second section has an effective angle of convergence from about 4° to about 65°, and the fourth section has an effective angle of divergence from about 4° to about 65°.

11. The method of claim 10, wherein the second section has an effective angle of convergence between about 4° and about 45°, and the fourth section has an effective angle of divergence between about 4° and about 63°.

12. The method of claim 10 wherein the ratio of cross-sectional areas of the first section to the third section ranges from about 5 to about 7, and the ratio of cross-sectional areas of the discharge section to the third section ranges from about 15 to about 30.

13. The method of claim 12, wherein the polymer cement is introduced through a slot in the first section.

14. The method of claim 9, wherein the second section has a decreasing inner diameter and the fourth section has an increasing inner diameter.

15. The method of claim 9, wherein the second section contains a plug having an increasing outer diameter and the fourth section has an increasing inner diameter.

16. The method of claim 9, wherein the solvent begins to de-volatize in the fourth section.

17. The method of claim 9, wherein the polymer is a conjugated diene polymer or copolymer.

18. The method of claim 9, wherein the polymer particles comprise between about 90% to about 98.5% by weight of the polymer.

19. The method of claim 9, wherein the high pressure steam is about 100 psig to about 350 psig.

20. The method of claim 9, wherein high pressure steam is combined with the polymer cement according to a weight ratio of from 0.4:1 to about 1:1.
